(19) United States
(12) Patent Application Publication
(10) Pub. No.: US 2024/0397436 A1
(43) Pub. Date: Nov. 28, 2024

(54) 5G AND RADAR ALTIMETER CO-EXISTENCE SYSTEM

(71) Applicant: T-Mobile Innovations LLC, Overland Park, KS (US)

(72) Inventors: Kafi HASSAN, Fairfax, VA (US); Nomaan MUFTI, McKinney, TX (US)

(21) Appl. No.: 18/322,083

(22) Filed: May 23, 2023

(51) Int. Cl. H04W 52/24; H04W 52/26

(52) U.S. Cl. CPC H04W 52/241; H04W 52/265

(57) ABSTRACT

Systems and methods are provided for 5G and aircraft altimeter radar co-existence that provides optimum and more accurate protection radius and optimum wireless access node (gNodeB) power setting level for safe interference levels. The strength of a signal from a wireless access node at the location of the radar altimeter is determined. The strength of the signal at the location of the radar altimeter is compared to a threshold to determine if the threshold is satisfied. In response to the strength of the signal satisfying the threshold, one or more parameters for the signal, including transmitter power level, are changed.

### TECHNICAL BACKGROUND

A wireless network, such as a cellular network, can include an access node (e.g., wireless access node) serving multiple wireless devices or user equipment (UE) in a geographical area covered by a radio frequency transmission provided by the access node. Access nodes may deploy different carriers within the cellular network utilizing different types of radio access technologies (RATs). RATs can include, for example, 3G RATs (e.g., GSM, CDMA etc.), 4G RATs (e.g., WiMax, LTE, etc.), and 5G RATs (new radio (NR)).

Further, different types of access nodes may be implemented for deployment for the various RATs. For example, a next generation NodeB (gNodeB or gNB) may be utilized for 5G RATs. Deployment of the evolving RATs in a network provides numerous benefits. For example, newer RATs may provide additional resources to subscribers, faster communications speeds, and other advantages. However, increased interference and latencies may be created due to higher power of the next generation NodeB (gNodeB or gNB).

In the United States, 5G wireless networks are continuing to expand throughout the country. 5G services are approved for radio frequencies in C-band (3.7 GHZ-3.98 GHZ) radio spectrum. 5G wireless networks co-exist with the nearby frequency band (4.2-4.4 GHZ) that is home to radar altimeters used on aircraft and helicopters worldwide. Radar altimeters are an important piece of safety equipment in aircraft.

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more examples of the present teachings and together with the description explain certain principles and operations. In the drawings:

FIG. 1 depicts a wireless network coexisting with radar altimeters, in accordance with disclosed examples.

FIG. 2 depicts a wireless network coexisting with radar altimeters.

FIG. 3 depicts a system and an interference engine, in accordance with the disclosed examples.

FIG. 4 depicts a flowchart illustrating an exemplary method for generating a protection area around a wireless access node, in accordance with the disclosed examples.

FIG. 5 depicts a flowchart illustrating an exemplary method for changing parameters of a signal of a wireless access node, in accordance with the disclosed examples.

### OVERVIEW

Various aspects of the present disclosure relate to systems, methods, and computer readable media for co-existence of 5G signals and radar altimeters. In an example, the system comprises at least one computing device, including at least one processor. The processor is configured to determine one or more locations of a radar altimeter. The strength of a signal from a wireless access node at the location of the radar altimeter is determined. The strength of the signal at the location of the radar altimeter is compared to a threshold to determine if the threshold is satisfied. In response to the strength of the signal satisfying the threshold, one or more parameters for the signal are changed.

The parameters that may be adjusted are transmitter power output and antenna array. In one example, the transmitter power output is decreased in response to the strength of the signal satisfying the threshold.

In examples, the location of the radar altimeter is determined by calculating a height of the radar altimeter from ground level and distance of the radar altimeter from a location on the ground. In this example, the radar altimeter is on an aircraft and the location on the ground is a landing location such as a runway or landing pad. In one example, the wireless access node is a gNodeB.

In some examples, the strength of a signal is determined by signal to noise ratio using data provided by the wireless access node. The threshold may be the maximum strength of the signal permitted.

Various aspects of the present disclosure relate to systems, methods, and computer readable media for generating a protection area around a wireless access node. Multiple locations of one or more radar altimeters are determined. The strength of a signal from a wireless access node is determined at each of the locations of one or more radar altimeters. The multiple locations and strength of the signal at each of the multiple locations is utilized to generate a protection area around the wireless access node.

In examples, the wireless access node is a gNodeB. In examples, it is determined if the strength of the signal at each of the locations satisfies a threshold. The protection area is the area around the gNodeB where the strength of the signal from the gNodeB is at or below a threshold.

In an example, in response to one or more of the signals at each of the locations satisfying a threshold, one or more parameters for the signal are changed. The parameters may be transmitter power output and antenna array. In one example, the transmitter power output of the wireless access node is decreased in response to the strength of the signal satisfying the threshold.

In examples, each of the multiple locations of the one or more radar altimeters is determined using height of the radar altimeter from the ground level and distance of the radar altimeter from a location on the ground. Flight path data and geographic information system (GIS) data may be utilized to determine each of the multiple locations.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In addition to the particular systems and methods described herein, the operations described herein may be implemented as computer-readable instructions or methods, and a processor on the network for executing the instructions or methods. The processor may include an electronic processor.

In the United States, 5G services are approved using frequencies in C-band (3.7 GHZ-3.98 GHZ) radio spectrum. These sub-blocks C3 and C4 are closest to the frequencies used by radar altimeters. The nearby frequency band (4.2-4.4 GHZ) is home to radar altimeters used on aircraft and helicopters worldwide.

As radar altimeters are an important piece of safety equipment in aircraft and the frequency bands of radar altimeters and 5G wireless are near one another, the FAA requires that radar altimeters be accurate and reliable without any interference from 5G services to prevent any hazardous interference. Radar altimeters are deployed on tens of thousands of commercial and general aviation aircraft as well as helicopters worldwide.

The radar altimeter is one of the most critical components to an aircraft's operations; and the only sensor onboard an aircraft providing a direct measurement of the aircraft's clearance over the terrain or other obstacles. This information is the most critical information in many automated landing and collision avoidance systems. Undetected failure of this sensor can therefore lead to catastrophic results; and false alarms have the potential to undermine trust in the avionics systems.

The aviation industry in the United States has raised concerns regarding the effect of 5G deployed in the 3700-3980 MHz range on radar altimeter use in aircrafts and helicopters in the nearby 4200-4400 MHz range (220 MHz away in frequency).

The system described herein is an efficient 5G and aircraft altimeter radar co-existence system that provides optimum and a more accurate protection radius (area) and optimum gNB (access node) power setting level for safe interference levels. The Federal Aviation Administration (FAA) defines “protection radius” as the distance between a gNodeB (access node) and an aircraft. The smaller the protection radius, the more airports an aircraft can access without landing or navigation restrictions.

The system described allows engineers to properly design and evaluate hazardous interference between 5G sites and altimeters at any landing/takeoff locations. The system enhances deployment and design of gNBs on C-band radio spectrum. The system will allow engineers to view graphically with 3D maps of airport surroundings/landing area with radar altimeter heights, distances and received signal level from near gNB sites and calculate optimum protection radius.

Turning now to the figures, various devices, systems, and methods in accordance with aspects of the present disclosure will be described.

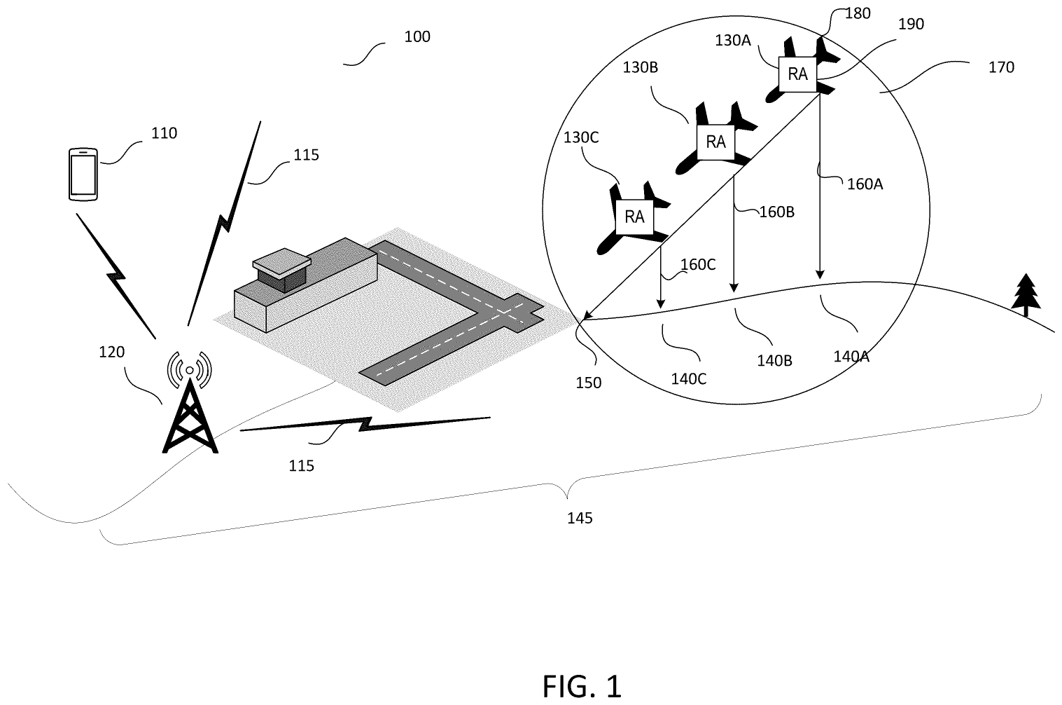

FIG. 1 depicts wireless environment 100 illustrating an access node 120 and radar altimeter 190. Wireless environment 100 includes a UE 110. The UE 110 may be a cell phone, mobile phone, wireless phone, as well as other types of devices or systems that are capable of radio frequency communication. UE 110 is capable of attaching to access node 120. Access node 120 may be operated by an Mobile Network Operator (MNO). While the wireless environment is depicted with a single UE 110, single access node 120 and single radar altimeter 190, it may comprise multiple UEs 110, access nodes 120 and radar altimeters 190.

Access node 120 may be for a wireless network, such as a cellular network, and can include a core network and a radio access network (RAN) serving multiple UEs 110 in a geographical area covered by a radio frequency transmission provided by the access network. As technology has evolved, different carriers (MNOs) within the cellular network may utilize different types of radio access technologies (RATs). RATs can include fifth generation (5G) RATs (new radio (NR)) and 6G. Further, different types of access nodes may be implemented within the access network for deployment for the various RATs. A next generation NodeB (gNB) may be utilized for 5G RATs. Deployment of the evolving RATs in a network provides numerous benefits. For example, newer RATs, such as 5G RATs, may provide additional resources to subscribers, faster communications speeds, and other advantages. However, increased interference may be created with radar altimeters due to higher power of the next generation NodeB (gNodeB or gNB).

5G deployed in the 3700-3980 MHz range and radar altimeter for aircrafts and helicopters use the nearby 4200-4400 MHz range (220 MHz away in frequency). The high power of the gNodeB in a 5G wireless network and the closeness of the frequency bands used by access node 120 and radar altimeters 190 may create interference with a radar altimeter 190 used by aircraft 180.

Aircraft 180 is a vehicle that is able to fly by gaining support from the air. Aircraft examples include airplanes, helicopters, airships (including blimps), gliders, spacecraft, and drones. An aircraft 180 landing is the last part of a flight, where a flying aircraft returns to ground 145. A normal aircraft flight would include several parts of flight including taxi, takeoff, climb, cruise, descent, and landing where the aircraft 180 will be at different locations in the air when not on the ground 145.

Aircraft 180 uses a radar altimeter 190 to measure the altitude/height of the aircraft from ground level. Radar altimeter 190 measures altitude above the terrain presently beneath aircraft 180 by timing how long it takes a beam of radio waves to travel to ground 145, reflect, and return to aircraft 180. Radar altimeters measure absolute altitude including the height above ground level (AGL). Radar altimeter 190 measures the distance between the antenna of radar altimeter 190 and the ground 145 directly below it. The height/altitude above the ground is calculated from the radio waves' travel time and the speed of light.

Radar altimeters 190 are essential devices regulated by the FAA and used by commercial aircraft for approach and landing, especially in low-visibility conditions. Radar altimeters are an essential part in ground proximity warning systems (GPWS), warning the pilot if the aircraft is flying too low or descending too quickly.

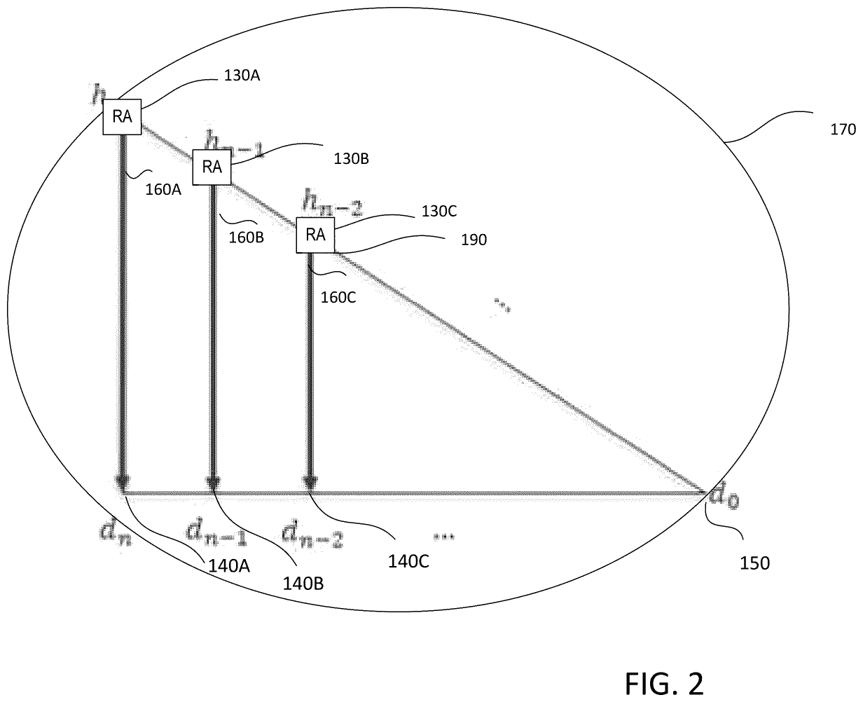

Referring to FIGS. 1 and 2, a location of a radar altimeter 190 can be determined by calculating a height of the radar altimeter 190 from ground level and distance of the radar altimeter 190 from a location on the ground 150 at a point in time. For example, the height of radar altimeter 190 at three different points in time is 160A, 160B, and 160C. The distance of the radar altimeter 190 at the same three points in time is 140A, 140B and 140C.

FIG. 2 shows the height (160A-160C) and distance (140A-140C) of the radar altimeter 190 at different times using the following equation.

dₙ,dₙ₋₁,dₙ₋₂, . . . d₀=distance from the location 150 on the ground (landing point).

hₙ,hₙ₋₁,hₙ₋₂, . . . h₀=height of radar altimeter 190 from ground 145

The height (160A-160C) and distance (140A-140C) of the radar altimeter 190 at three different times is used to calculate the locations 130A, 130B and 130C of the radar altimeter 190 at the three points in time. Data for the radar altimeter 190 to calculate the height, distance, and location at different points in time may be received from the radar altimeter 190 or may be accessed from a database such as an airport database and GIS database. Although the radar altimeter 190 is depicted in FIGS. 1 and 2 as a single radar altimeter at different points in time, one or more locations for multiple radar altimeters may be determined and utilized by the system.

Referring again to FIG. 1, the signal strength at each of locations 130A, 130B, and 130C may be determined from signal 115 of access node 120. Signal strength is the transmitter power output of access node 120 as received by a reference antenna at a distance from the transmitting antenna. For very low-power systems, such as mobile phones, signal strength is usually expressed in dB-microvolts per meter (dBuV/m) or in decibels above a reference level of one milliwatt (dBm).

Referring to FIG. 2, at each location point (such as 130A, 130B, and 130C, the strength of the signal from a nearby access node, such as a gNB, is measured from location points along the aircraft landing path/trajectory using the following equation.

sₙ,sₙ₋₁,sₙ₋₂, . . . s₀=signal strength of near gNB

Access node 120 has data for determining signal strength. In one example, data from access node 120 can be used to calculate a signal-to-noise ratio at location points in the flight path, such as 130A, 130B and 130C. The signal strength values may be estimates at the location points in the flight path.

Signal strength at a location point may be a signal-to-noise ratio (SNR) that compares the level of a desired signal to the level of background noise. SNR is the ratio of signal power to noise power, often expressed in decibels. A ratio higher than 1:1 (greater than 0 dB) indicates more signal than noise. SNR is an important parameter that affects the performance and quality of systems that process or transmit signals, such as communication systems, audio systems, radar systems, imaging systems, and data acquisition systems. A high SNR means that the signal is clear and easy to detect or interpret, while a low SNR means that the signal is corrupted or obscured by noise and may be difficult to distinguish or recover.

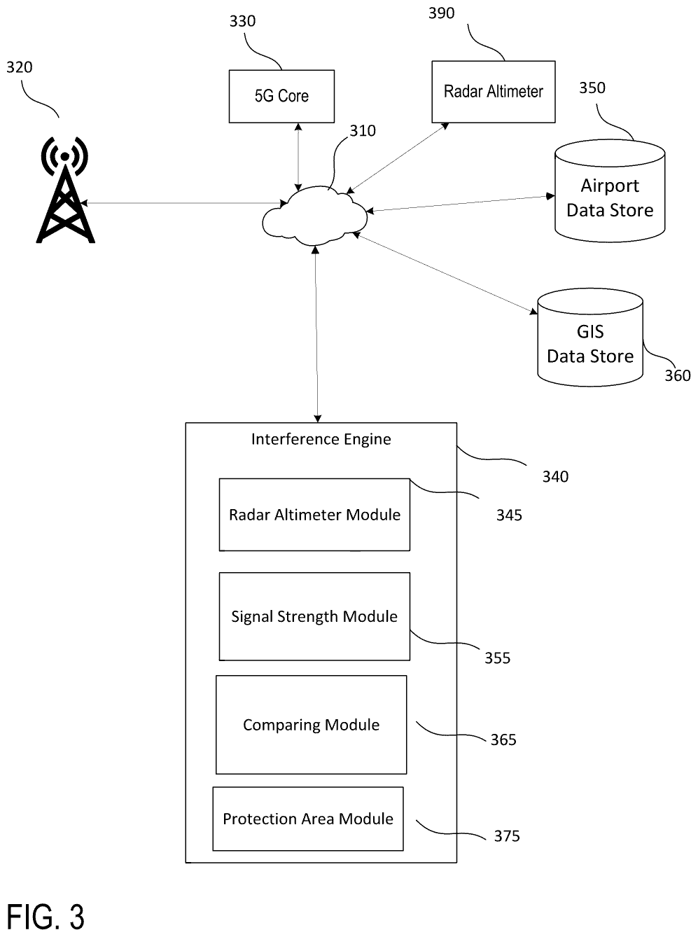

The data used for obtaining location of radar altimeter 190, height of radar altimeter 190, distance of radar altimeter 190 from a location on the ground 150 and signal strength at one or more locations of radar altimeter 190 obtained from databases (such as GIS database and airport database of FIG. 3), access node 120 and radar altimeter 190, there is no need for engineers to take actual measurements at location points along the flight path.

Protection area 170 may be calculated by comparing the signal strength at locations of one or more radar altimeters with a threshold. The threshold may be the maximum strength of the signal permitted. For example, the threshold may the maximum strength of a 5G signal from an access node 120 (gNB) at points on the flight path.

A protection area 170 is the area along a flight path where the signal strength is determined to be at acceptable thresholds. The protection area 170 may be a radius of safe operation where 5G signals from access node 120 are at or below an acceptable level and will cause minimal interference with radar altimeter 190. The protection area 170 may be associated with an optimum power setting needed for an access node 120 near a flight path.

The protection area 170 may be depicted graphically as a map, such as that shown in FIGS. 1 and 2. The graphical user interface may be user interactive such that a user, such as a network engineer, can select different location points on a graphical map to access signal strength and model potential changes to the protection area 170 based on changing parameters, such as transmit power and antenna array for access node 120. The graphical user interface may also depict graphical animations of an aircraft landing using a landing flight path depicting signal strength at various location points and protection area 170.

In addition to generating a protection area 170, parameters for the signal from wireless access node 120 may be tuned. For example, if the signal strength at locations along a flight path exceed a maximum threshold, wireless access node 120 may adjust parameters of the signals. For example, the transmit power of the signal or positioning of antenna arrays from the wireless access node 120 are adjusted such that the signal strength at locations along a flight path are below a threshold limiting interference with radar altimeter 190.

The signal strength threshold may be defined by the FAA and changes over time and circumstances. When adjusting parameters, a buffer, such as setting the signal strength to 1 or 2 dB lower than the threshold may be made to the transmit power settings of wireless access node 120.

FIG. 3 illustrates a system 300 for 5G and radar altimeter co-existence. For purposes of illustration and explanation, the system 300 is illustrated as a 5G System (5GS); however, in practical implementations the system 300 may correspond to any RAT or combinations of RATs, including but not limited to 3G RATs such as GSM, UMTS, CDMA, etc.; 4G RAs such as WiMAX, LTE, etc.; 5G RATs such as NR, 6G; and further extensions or updated implementations of the same.

As illustrated, the system 300 comprises a network 310, an access node 320, a 5G core 330, which provide service in a coverage area, an interference engine 340, airport database 350, GIS database 360, and radar altimeter 390. For purposes of illustration and ease of explanation, only one access node 320 and radar altimeter 390 are shown in the system 300; however, as noted above with regard to FIG. 1, additional access nodes and/or additional radar altimeters 390 may be present in the system 300.

In the illustration of FIG. 3, the access node 320 is connected to the network 310 via an NR path (including the 5G core 220); however, in practical implementations the access node 320 may be connected to network 310 via multiple paths (e.g., using multiple RATs). The access node 320 may communicate with the 5G core 330 via one or more communication links, each of which may be a direct link. However, it will be appreciated that network 310 may be any type of network facilitating communication among access node 320, 5G core 330, interference engine 340, airport database 350, GIS database 360, and radar altimeter 390.

The access node 320 may be any network node configured to provide communications between the connected wireless devices. As examples of a standard access node, the access node 320 may be a gNodeB in 5G networks, an eNodeB in 4G/LTE networks, or the like, including combinations thereof. Access node 320 may also provide data to interference engine 340 regarding signal strength.

An interference engine 340 is in communication with the access node 320 and/or the 5G core 330. Interference engine 340 may be configured to monitor signal strength of an access node 320 along a flight path.

Geographic information system (GIS) database 360 is a computer system for capturing, storing, and providing data related to positions on Earth's surface. GIS database 360 has a system of points with known positions, elevations, or both for use in determining ground elevation and radar altimeter positions at various locations. GIS database 360 may include data for flight landing locations such as runways and landing pads, streets, and buildings. GIS database 360 may have 3-dimensional information for graphically depicting ground elevation and positions at various locations.

Airport database 350 is a computer system for capturing, storing and providing data related to airport and aeronautical data such as takeoff/landing data flight, altimeter data, engine out procedures (EOP), Notice to Airmen (NOTAM) of potential hazards along a flight route, runway and flight pad location, frequencies, navigation, runway maps for use in determining radar altimeter positions at different locations. Exemplary airport databases include Airport Data and Information Portal (ADIP) of the FAA and Global Airport Database (GADB).

The interference engine 340 can comprise one or more electronic processors and associated circuitry to execute or direct the execution of computer-readable instructions such as those described herein. In so doing, the interference engine 340 can retrieve and execute software from storage, which can include a disk drive, a flash drive, memory circuitry, or some other memory device, and which may be local or remotely accessible. The software may comprise computer programs, firmware, or some other form of machine-readable instructions, and may include an operating system, utilities, drivers, network interfaces, applications, or some other type of software, including combinations thereof. Moreover, the interference engine 340 can receive instructions and other input at a user interface.

As illustrated the interference engine 340 utilizes a modular controller, a memory, wireless communication circuitry, and a bus through which the various elements of the interference engine 340 may communicate with access node 320, 5G core 330, airport database 350, GIS database 360, and radar altimeter 390. The modular controller is one example of an electronic processor, and may include sub-modules or units, each of which may be implemented via dedicated hardware (e.g., circuitry), software modules which are loaded from the memory and processed by the controller, firmware, and the like, or combinations thereof.

The modules include a radar altimeter module 345, signal strength module 355, a comparing module 365, and protection area module 375. Some or all of the sub-modules or units may physically reside within the controller or may instead reside within the memory and/or may be provided as separate units, in any combination. The various sub-modules or units may include or implement logic circuits, thereby performing operations such as setting parameters, monitoring parameters, comparing parameters, and generating instructions.

While FIG. 3 illustrates the radar altimeter module 345, signal strength module 355, a comparing module 365, and protection area module 375 as being separate modules, in practical implementations some of the modules may be combined with one another and/or may share components. The radar altimeter module 345, signal strength module 355, a comparing module 365, and protection area module 375 may be configured to perform various operations to implement methods in accordance with the present disclosure. While one example of operations performed by the modules is described here, in practical implementations at least some of the operations described as being performed by one module may instead be performed by another module, including a module not explicitly named here.

The radar altimeter module 345 may be configured to determine the location of the radar altimeter 390 by accessing data from radar altimeter 390, airport database 350 and GIS database 360. Radar altimeter module 345 utilizes the data to determine one or more location points for one or more radar altimeters 390. Location of radar altimeter 390 can be determined by calculating height of the radar altimeter 390 from ground level and distance of the radar altimeter 390 from a location on the ground at a point in time. The height of the altimeter from the ground level at a point in time may be accessed from airport database 350 or directly from radar altimeter 390 with measurements of radar altimeter 390 at a location at a point in time.

The distance of the radar altimeter 190 at the same point in time can be determined by accessing data from airport database 350 and GIS database 360. The airport database 350 can provide longitude/latitude coordinates for the radar altimeter at given points and time. The GIS database provides the coordinates of a location on the ground (e.g., runway, landing pad). The distance between the longitude/latitude coordinates the radar altimeter at a given point and the location on the ground (e.g., runway, landing pad) is calculated to determine the distance of the radar altimeter from a location on the ground (e.g., runway, landing pad).

Using the height of the radar altimeter 390 and the distance of the radar altimeter 390 from a location on the ground, a location of the radar altimeter at a point in time in the air is determined. Radar altimeter module 345 may determine multiple locations of one or more radar altimeters.

The signal strength module 355 may be configured to determine the signal strength of a signal from an access node 320 at a location of radar altimeter 390. Accesses data from access node 320 about strength of signal. For example, signal strength module 355 accesses data from access node 320 to calculate the strength of a signal from the access node 320 at a location, such as a location of a radar altimeter determined by radar altimeter module 345.

The comparing module 365 may be configured with various logic circuits or elements in order to various logic operations, including but not limited to, operations of comparing the signal strength determined by signal strength module 355 at the locations determined by the radar altimeter module 345 and to a threshold. The signal strength at locations of one or more radar altimeters with a threshold. The threshold may be the maximum strength of the signal permitted. For example, the maximum strength of the signal permitted may be set by the FAA.

The comparing module 365 may cause changes to be made to a signal of a wireless access node in response to the strength of the signal satisfying the threshold. For example, one or more parameters for the signal may be changed in response to one or more of the signals at each of the locations satisfying a threshold. Exemplary parameters that may be changed are transmit power and changing the antenna array such that the area along the flight path (radar altimeter locations) are at or below a threshold for strength of a signal from a wireless access node (5Gnb) change one or more parameters for the signal. In one example, the transmitter power output is decreased in response to the strength of the signal satisfying the threshold so that the strength of the signal at the radar altimeter locations is acceptable and will not cause interference with radar altimeters of aircrafts along a flight path.

The protection area module 375 may be configured to determine the strength of a signal from a wireless access node at multiple locations of one or more radio altimeters. The protection area module 375 utilizes the multiple locations and strength of the signal at each of the multiple locations to generate a protection area around the wireless access node. For example, the protection area module 375 may draw a protection area as the area around a flight path where the strength of a signal from a wireless access node does not exceed a threshold. For example, the protection area may be the area along a flight path where the strength of the signal from a wireless access node is at or below a threshold. For example, the strength of the signal is at or below a threshold defined by the FAA. The protection area may be a protection radius around a gNodeB. The protection area module 375 may graphically depict the protection area on an interactive graphical interface.

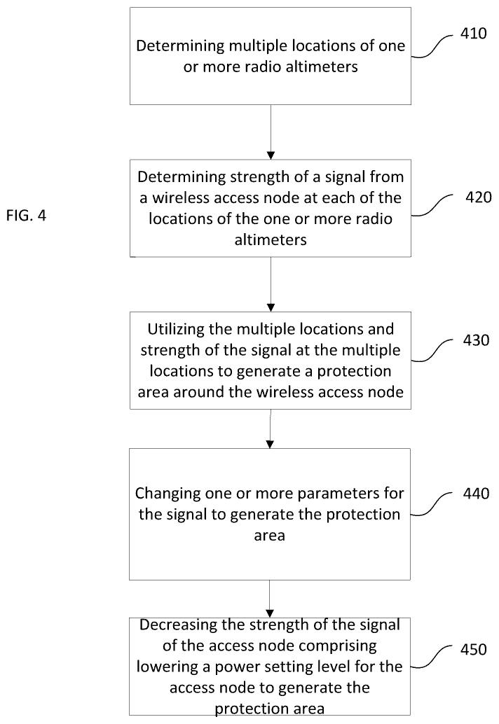

FIG. 4 illustrates an exemplary process flow for generating a protection area for a wireless access node. The operations of FIG. 4 will be described as being performed by the interference engine 340 for purposes of explanation. In other implementations, the operations may be performed by or under the control of a processor of a wireless access node, 5 g core or processed in a cloud environment.

The process flow begins at operation 410, when multiple locations of one or more radar altimeters are determined. It will be appreciated that the multiple locations may be determined for multiple radar altimeters and at different points in time. Data may be accessed from the radar altimeter, airport database and GIS database to determine the multiple locations of one or more radar altimeters. Locations of radar altimeters can be determined by calculating height of a radar altimeter from ground level and distance of a radar altimeter from a location on the ground at a point in time.

Using the height of a radar altimeter and the distance of the radar altimeter from a location on the ground, a location of the radar altimeter at a point in time in the air is determined.

At operation 420, strength of a signal from a wireless access node is determined for each of the locations of the one or more radar altimeters. In one example, data from a wireless access node can be used to calculate a signal-to-noise ratio at location points (one or more locations of one or more radar altimeters) in the flight path. The signal strength values may be estimates at the location points in the flight path. Signal strength at a location point may be a signal-to-noise ratio (SNR) that compares the level of a desired signal to the level of background noise.

At operation 430, utilize the multiple locations and strength of the signal at each of the multiple locations to generate a protection area around the wireless access node. The protection area may be calculated by comparing the signal strength at locations of one or more radar altimeters with a threshold. The threshold may be the maximum strength of the signal permitted. For example, the maximum strength of the signal permitted may be set by the FAA. The maximum strength of a 5G signal from an access node (gNB) at the multiple locations of the one or more radar altimeters.

A protection area may be the area along a flight path where the signal strength is determined to be at acceptable thresholds. The protection area may be a radius of safe operation where 5G signals from access node are at or below an acceptable level will cause minimal interference with radar altimeter. The protection area may be associated with an optimum power setting needed for an access node near a flight path.

At operation 440, one or more parameters are changed for the signal to generate the protection area. One or more parameters for the signal from wireless access node may be tuned. For example, if the signal strength at locations along a flight path exceeds a maximum threshold, a wireless access node may adjust parameters of the signals. For example, the transmit power of the signal or positioning of antenna arrays from the wireless access node are adjusted such that the signal strength at locations along a flight path are below a threshold limiting interference with radar altimeter. A new protection area is generated based on the changes to the parameters.

At operation 450, the transmitter power output is decreased in response to the strength of the signal satisfying the threshold, the transmitter power output is decreased such that the strength of the signal at the radar altimeter locations is acceptable (at or below FAA maximum threshold) and will not cause interference with radar altimeters of aircrafts along a flight path.

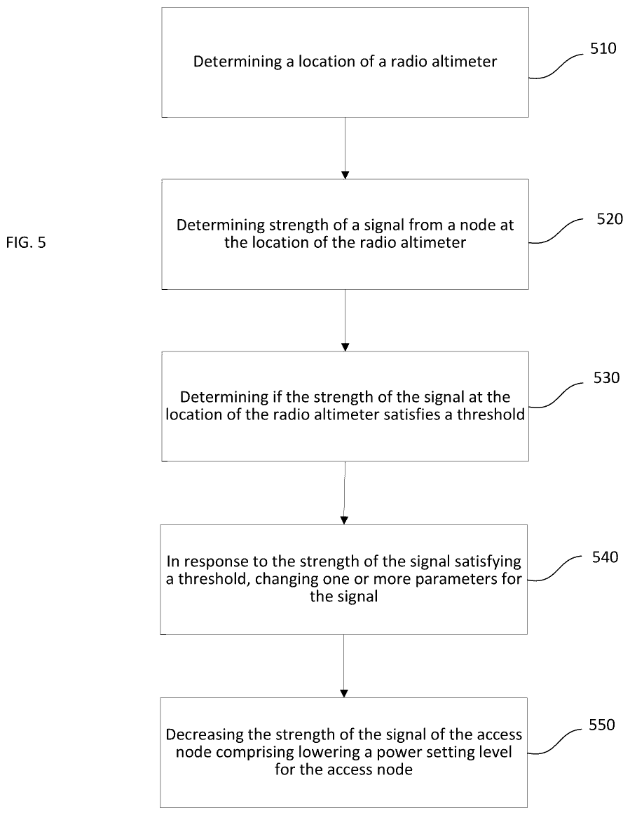

FIG. 5 illustrates an exemplary process flow for changing parameters for a signal from a wireless access node in response to the strength of the signal satisfying a threshold. The operations of FIG. 5 will be described as being performed by the interference engine 340 for purposes of explanation. In other implementations, the operations may be performed by or under the control of a processor of a wireless access node, 5 g core or processed in a cloud environment.

At operation 510, determine a location of a radar altimeter; Data may be accessed from the radar altimeter, airport database and GIS database to determine the multiple locations of one or more radar altimeters. Locations of radar altimeters can be determined by calculating height of a radar altimeter from ground level and distance of a radar altimeter from a location on the ground at a point in time.

Using the height of a radar altimeter and the distance of the radar altimeter from a location on the ground, a location of the radar altimeter at a point in time in the air is determined.

At operation 520, the strength of a signal from a wireless access node at the location of the radar altimeter is determined. In one example, data from a wireless access node can be used to calculate a signal-to-noise ratio at location points (one or more locations of one or more radar altimeters) in the flight path. The signal strength values may be estimates at the location points in the flight path. Signal strength at a location point may be a signal-to-noise ratio (SNR) that compares the level of a desired signal to the level of background noise.

At operation 530, determine if the strength of the signal at the location of the radar altimeter satisfies a threshold. The signal strength at locations of one or more radar altimeters is compared to a threshold. The threshold may be the maximum strength of the signal permitted. For example, the maximum strength of the signal permitted may be set by the FAA. The maximum strength of a 5G signal from an access node at the location of the radar altimeter.

At operation 540, in response to the strength of the signal satisfying the threshold, change one or more parameters for the signal. One or more parameters for the signal from wireless access node may be tuned. For example, if the signal strength at locations along a flight path exceeds a maximum threshold, a wireless access node may adjust parameters of the signals. For example, the transmit power of the signal or positioning of antenna arrays from the wireless access node are adjusted such that the signal strength at locations along a flight path are below a threshold limiting interference with radar altimeter.

At operation 550, transmitter power output is decreased in response to the strength of the signal satisfying the threshold. The transmitter power output is decreased such that the strength of the signal at the radar altimeter locations is acceptable (at or below FAA maximum threshold) and will not cause interference with radar altimeters of aircrafts along a flight path.

The operations of FIGS. 4 and 5 need not necessarily be performed one after another in immediate sequence. While the above descriptions illustrate various aspects of the present disclosure, the present disclosure is not so limited. The methods and operations described above may be performed in an iterative matter. These additional iterations may also be reverted in a manner similar to that described above.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention and are intended to be illustrative and not restrictive. Many examples and applications other than the examples provided would be apparent to those skilled in the art upon reading the above description. The scope should be determined, not with reference to the above description, but instead with reference to the appended claims, along with the full scope of equivalents to which such claims are entitled. It is anticipated and intended that future developments will occur in the technologies discussed herein, and that the disclosed systems and methods will be incorporated into future examples. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, the use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. A system comprising:
at least one computing device, including at least one processor configured to:
determine a location of a radar altimeter;
determine strength of a signal from a wireless access node at the location of the radar altimeter;
determine if the strength of the signal at the location of the radar altimeter satisfies a threshold; and
in response to the strength of the signal satisfying the threshold, change one or more parameters for the signal.

2. The system of claim 1, wherein the location of the radar altimeter is determined by calculating a height of the radar altimeter from ground level and distance of the radar altimeter from a location on ground.

3. The system of claim 2, wherein the radar altimeter is on an aircraft.

4. The system of claim 3, wherein the location on the ground is a landing location.

5. The system of claim 1, wherein the wireless access node is a gNodeB.

6. The system of claim 1, wherein strength of signal is determined by signal to noise ratio with data from the wireless access node.

7. The system of claim 1, wherein the threshold is maximum strength of the signal permitted.

8. The system of claim 1, wherein the parameters are transmitter power output and antenna array.

9. The system of claim 8, wherein the transmitter power output is decreased in response to the strength of the signal satisfying the threshold.

10. A system comprising:
at least one computing device, including at least one processor configured to:
determine multiple locations of one or more radar altimeters;
determine strength of a signal from a wireless access node at each of the locations of the one or more radar altimeters; and
utilize the multiple locations and strength of the signal at each of the multiple locations to generate a protection area around the wireless access node.

11. The system of claim 10, wherein the one or more radar altimeters are on an aircraft.

12. The system of claim 11, wherein the wireless access node is a gNodeB.

13. The system of claim 12, wherein the protection area is area around the gNodeB where the strength of the signal from the gNodeB is at or below a threshold.

14. The system of claim 10, wherein the at least one processor is further configured to:
determine if the strength of the signal at each of the locations satisfies a threshold.

15. The system of claim 14, wherein the at least one processor is further configured to:
in response to one or more the signals at each of the locations satisfying a threshold, change one or more parameters for the signal.

16. The system of claim 15, wherein the parameters are transmitter power output and antenna array.

17. The system of claim 16, wherein the transmitter power output is decreased in response to the strength of the signal satisfying the threshold.

18. The system of claim 10, wherein each of the multiple locations of the one or more radar altimeters are determined using height of the one or more radar altimeters from ground level and distance of the one or more radar altimeter from a location on the ground.

19. The system of claim 18, wherein the at least one processor is further configured to:
utilize flight path data and geographic information system (GIS) data to determine each of the multiple locations.

20. The system of claim 19, wherein the location on the ground is a landing location.
